(19) United States
(12) Patent Application Publication
(10) Pub. No.: US 2013/0147920 A1
(43) Pub. Date: Jun. 13, 2013

(54) IMAGING DEVICE

(71) Applicant: Panasonic Corporation, Osaka (JP)

(72) Inventors: Kuniyoshi KOBAYASHI, Osaka (JP); Masahiro MURAKAMI, Kyoto (JP); Osafumi MORIYA, Osaka (JP)

(73) Assignee: Panasonic Corporation, Osaka (JP)

(21) Appl. No.: 13/760,001

(22) Filed: Feb. 5, 2013

Related U.S. Application Data
(63) Continuation of application No. PCT/JP2011/002941, filed on May 26, 2011.

(30) Foreign Application Priority Data
Aug. 6, 2010 (JP) 2010-178139

(51) Int. Cl. G03B 13/36

(52) U.S. Cl. CPC G03B 13/36
USPC 348/46

(57) ABSTRACT

The imaging device includes an optical system, imaging unit, and control unit. The optical system is configured to include a focus lens. The imaging unit is configured to capture a left-eye subject and a right-eye subject via the optical system. A image captured by the imaging unit includes a left-eye image for the left-eye subject and the right-eye image for the right-eye subject. The control unit is configured to generate a first AF evaluation for the left-eye image and a second AF evaluation for the right-eye image. The control unit generates a third AF evaluation value on the basis of the first AF evaluation value and the second AF evaluation value. The control unit controls the drive of the focus lens on the basis of the third AF evaluation value.

### PRIORITY

This is a continuation-in-part under 35 U.S.C. §120 and 35 U.S.C. §365 of International Application PCT/JP2011/002941, with an international filing date of May 26, 2011 which claims priority to Japanese Patent Application No. 2010-178139 filed on Aug. 6, 2010. The entire disclosures of International Application PCT/JP2011/002941 and Japanese Patent Application No. 2010-178139 are hereby incorporated herein by reference.

### BACKGROUND

1. Technical Field

The technology disclosed herein relates to an imaging device, and more particularly relates to an imaging device to which a 3D conversion lens can be attached.

2. Background Information

Japanese Laid-Open Patent Application H3-63638 discloses a three-dimensional imaging device. This three-dimensional imaging device has two line sensors. This three-dimensional imaging device compares the focal states of images captured by the two line sensors, and adjusts the focal state of each. Consequently, this three-dimensional imaging device has a better video effect with three-dimensional images.

### SUMMARY

However, the above-mentioned Japanese Laid-Open Patent Application H3-63638 does not disclose a device for properly evaluating the extent to which defocus occurs between a left-eye image and a right-eye image in the capture of a 3D image in side-by-side format.

It is an object of the present technology to provide an imaging device with which defocus of the left-eye image and the right-eye image can be reduced in the capture of a 3D image in side-by-side format.

The imaging device disclosed herein includes an optical system, imaging unit, and control unit. The optical system is configured to include a focus lens. The imaging unit is configured to capture a left-eye subject and a right-eye subject via the optical system. A image captured by the imaging unit includes a left-eye image for the left-eye subject and the right-eye image for the right-eye subject. The control unit is configured to generate a first AF evaluation for the left-eye image and a second AF evaluation for the right-eye image. The control unit generates a third AF evaluation value on the basis of the first AF evaluation value and the second AF evaluation value. The control unit controls the drive of the focus lens on the basis of the third AF evaluation value.

The present technology provides an imaging device with which defocus of the left-eye image and the right-eye image can be reduced in the capture of a 3D image in side-by-side format.

### BRIEF DESCRIPTION OF DRAWINGS

Referring now to the attached drawings, which form a part of this original disclosure:

FIG. 1 is an oblique view of a state in which a 3D conversion lens 500 has been attached to a digital video camera 100;

FIG. 2 is a simplified diagram illustrating image data captured by the digital video camera 100 in a state in which the 3D conversion lens 500 has been attached;

FIG. 3 is a block diagram of the configuration of the digital video camera 100;

FIG. 4 is a simplified diagram illustrating contrast AF in 2D mode;

FIG. 5 is a simplified diagram illustrating contrast AF in 3D mode;

FIG. 6 is a flowchart illustrating contrast AF in 3D mode; and

FIG. 7 is a simplified diagram illustrating AF evaluation values for a captured image.

### DETAILED DESCRIPTION

Selected embodiments of the present technology will now be explained with reference to the drawings. It will be apparent to those skilled in the art from this disclosure that the following descriptions of the embodiments of the present technology are provided for illustration only and not for the purpose of limiting the technology as defined by the appended claims and their equivalents.

### Embodiment

Embodiment 1 in which the present technology is applied to a digital video camera will be described through reference to the drawings It will be apparent to those skilled in the art from this disclosure that the following descriptions of the embodiments are provided for illustration only and not for the purpose of limiting the technology as defined by the appended claims and their equivalents.

### 1. Embodiment 1

1-1. Overview

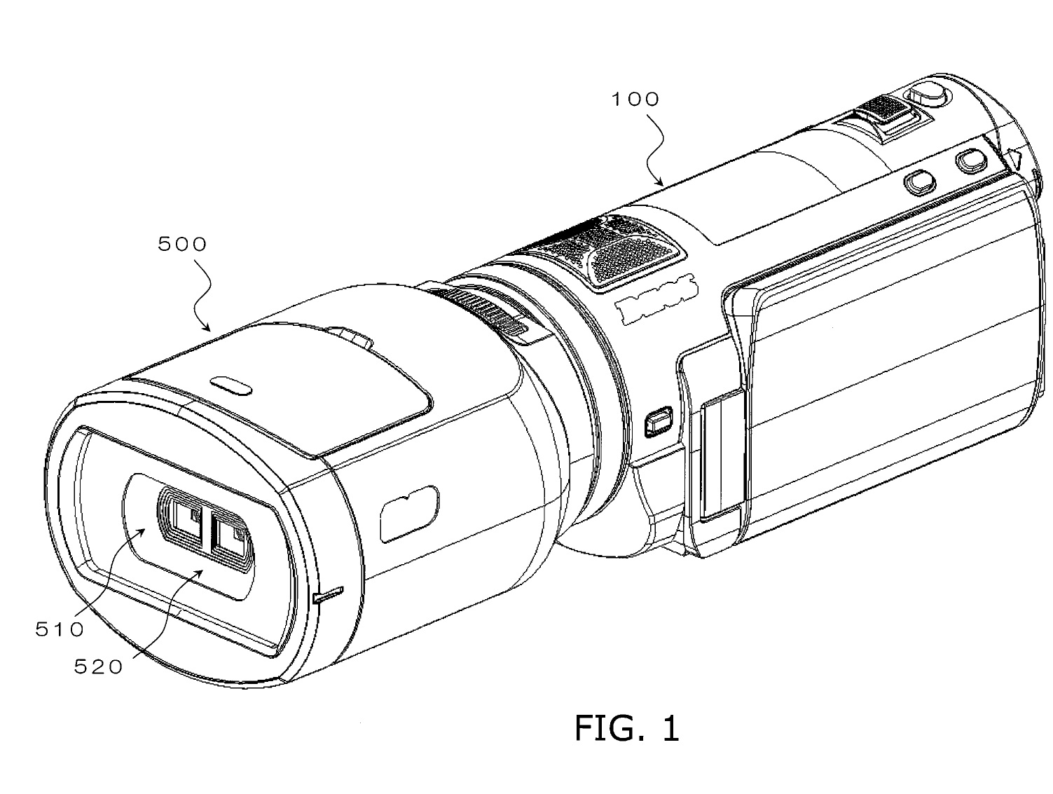

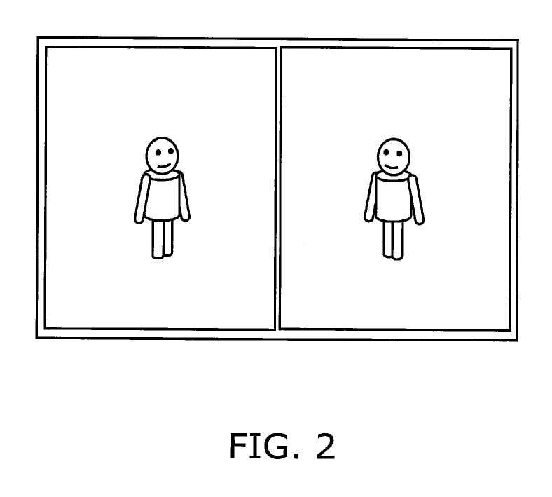

An overview of the digital video camera 100 pertaining to Embodiment 1 will be described through reference to FIGS. 1 and 2. FIG. 1 is an oblique view of a state in which the 3D conversion lens 500 has been attached to the digital video camera 100. FIG. 2 is a simplified diagram illustrating image data captured by the digital video camera 100 in a state in which the 3D conversion lens 500 has been attached.

The 3D conversion lens 500 can be removably attached to an attachment component (not shown) of the digital video camera 100. The digital video camera 100 uses a detector switch (not shown) to magnetically detect the attachment of the 3D conversion lens 500.

The 3D conversion lens 500 is an image output unit for outputting light for forming a left-eye image and light for forming a right-eye image in a 3D (three-dimensional) image. More specifically, the 3D conversion lens 500 has a right-eye lens 510 and a left-eye lens 520. The right-eye lens 510 is used to guide light for forming the right-eye image in a 3D image to the optical system of the digital video camera 100. The left-eye lens 520 is used to guide light for forming the left-eye image in the 3D image to the optical system.

The light incident through the 3D conversion lens 500 is formed into the side-by-side 3D image shown in FIG. 2 on a CCD image sensor 180 of the digital video camera 100. That is, with the digital video camera 100, a 3D image is captured in side-by-side format in a state in which the 3D conversion lens 500 has been attached (3D mode). Also, with the digital video camera 100, a 2D image is captured in a state in which the 3D conversion lens 500 has been removed (2D mode).

The digital video camera 100 pertaining to Embodiment 1 reduces defocus of a left-eye image and a right-eye image in a side-by-side 3D image such as this.

1-2. Configuration

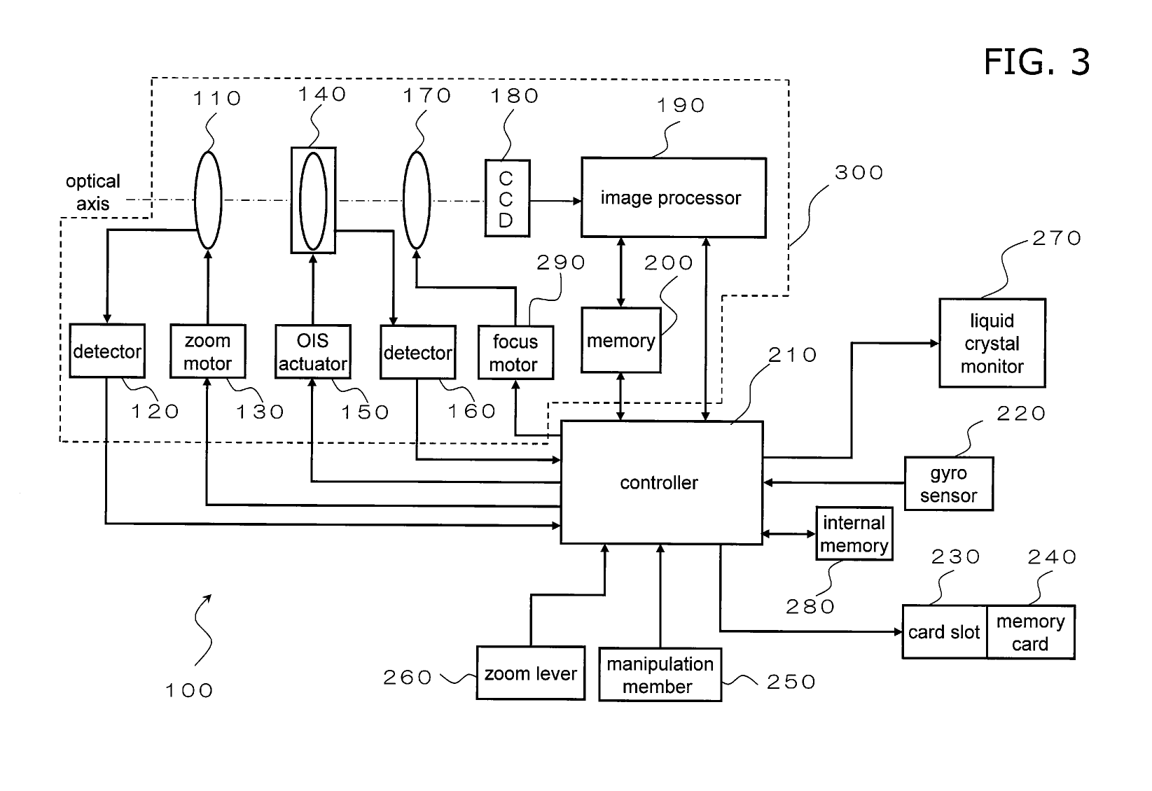

The electrical configuration of the digital video camera 100 pertaining to Embodiment 1 will be described through reference to FIG. 3. FIG. 3 is a block diagram of the configuration of the digital video camera 100. The digital video camera 100 uses the CCD image sensor 180 to capture a subject image formed by the optical system. The optical system is made up of a zoom lens 110, etc. The video data generated by the CCD image sensor 180 is subjected to various kinds of processing by an image processor 190, and stored on a memory card 240. The video data stored on the memory card 240 can be displayed on a liquid crystal monitor 270. The configuration of the digital video camera 100 will now be described in detail.

The optical system of the digital video camera 100 includes the zoom lens 110, an OIS 140 (optical image stabilizer), and a focus lens 170. The zoom lens 110 can enlarge or reduce the subject image by moving along the optical axis of the optical system. The focus lens 170 also adjusts the focus of the subject image by moving along the optical axis of the optical system. A focus motor 290 drives the focus lens 170.

The OIS 140 has an correcting lens therein. The correcting lens is configured to move in a plane perpendicular to the optical axis. The OIS 140 reduces blurring of the subject image by driving the correcting lens in the direction of canceling out shake of the digital video camera 100.

A zoom motor 130 drives the zoom lens 110. The zoom motor 130 may be a pulse motor, a DC motor, a linear motor, a servo motor, or the like. The zoom motor 130 may drive the zoom lens 110 via a cam mechanism, a ball screw, or another such mechanism. A detector 120 detects whether or not the zoom lens 110 is at a location on the optical axis. The detector 120 outputs a signal related to the position of the zoom lens according to the movement of the zoom lens 110 in the optical axis direction by means of a brush or other such switch.

An OIS actuator 150 drives the correcting lens within the OIS 140 in a plane that is perpendicular to the optical axis. The OIS actuator 150 is implemented by a flat coil, an ultrasonic motor, or the like. A detector 160 detects the amount of movement of the correcting lens within the OIS 140.

The CCD image sensor 180 produces video data by capturing the subject image formed by the optical system which includes the zoom lens 110, etc. The CCD image sensor 180 performs exposure, transfer, electronic shuttering, and various other operations.

The image processor 190 subjects the image data produced by the CCD image sensor 180 to various kinds of processing. The image processor 190 subjects the image data produced by the CCD image sensor 180 to processing, producing video data for display on the liquid crystal monitor 270, and producing video data for storage on the memory card 240. For example, the image processor 190 subjects the video data produced by the CCD image sensor 180 to gamma correction, white balance correction, scratch correction, and various other kinds of processing. The image processor 190 also subjects the video data produced by the CCD image sensor 180 to compression in a format conforming to H.264 or MPEG2. The image processor 190 is implemented by a DSP (digital signal processor), a microprocessor, or the like.

A controller 210 is a control unit for controlling the entire system. The controller 210 is implemented by a semiconductor element or the like. The controller 210 may be made up of hardware alone, or may be implemented by a combination of hardware and software. The controller 210 is implemented by a microprocessor or the like.

A memory 200 functions as a working memory for the image processor 190 and the controller 210. The memory 200 can be a DRAM, a ferroelectric memory, or the like.

The liquid crystal monitor 270 displays an image indicated by the video data produced by the CCD image sensor 180, and/or an image indicated by video data read from the memory card 240.

A gyro sensor 220 is made up of a piezoelectric element or other such vibrating member, etc. The gyro sensor 220 converts the Coriolis force into voltage by vibrating the piezoelectric element or other such vibrating member at a specific frequency, and outputs angular velocity information based on the voltage. The digital video camera 100 corrects shaking of the user's hands by driving the correcting lens within the OIS 140 in the direction of canceling out the shake indicated by the angular velocity information from the gyro sensor 220.

A card slot 230 allows the memory card 240 to be inserted and removed. The card slot 230 allows mechanical and electrical connection with the memory card 240. The memory card 240 includes internally a flash memory, a ferroelectric memory, or the like, and store data.

An internal memory 280 is made up of a flash memory, a ferroelectric memory, or the like. The internal memory 280 stores control programs and so forth for controlling the digital video camera 100 as a whole.

A manipulation member 250 is manipulated by the user. A zoom lever 260 is operated by the user to change the zoom ratio.

In this embodiment, the optical systems 110, 140, and 170, various devices 120, 130, 150, 160, and 290 for driving and controlling the optical systems 110, 140, and 170, the CCD image sensor 180, the image processor 190, and the memory 200 are defined as an imaging system 300.

1-3. Contrast AF (Auto Focus)

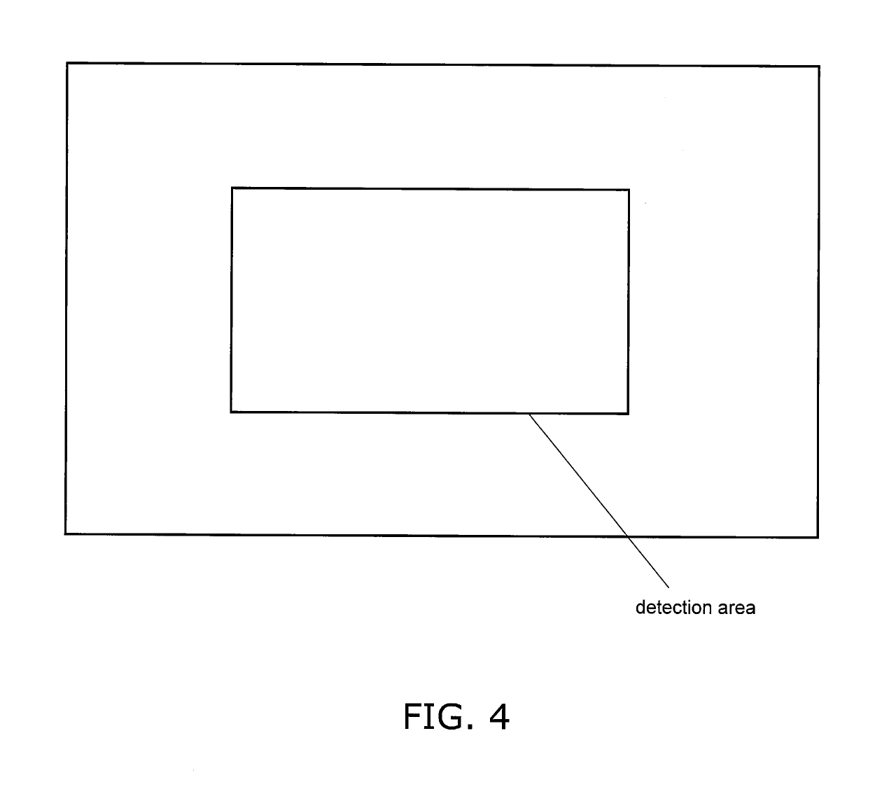

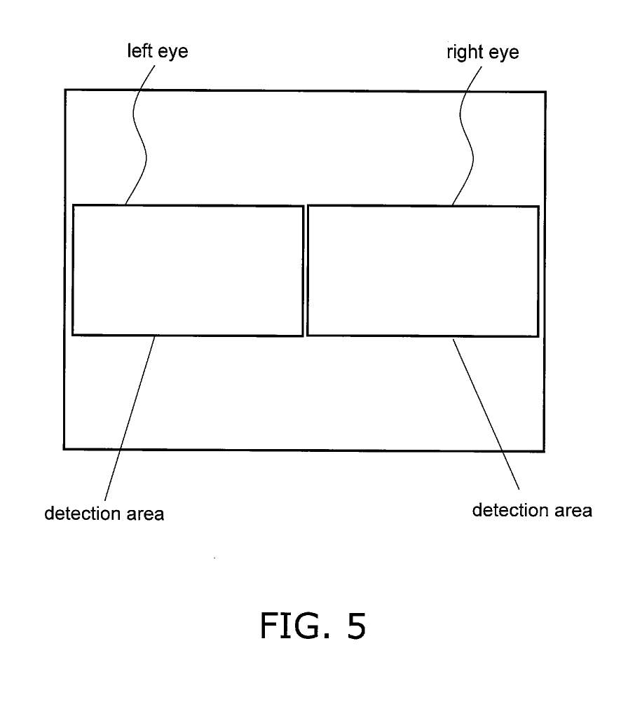

Contrast AF will be described through reference to FIGS. 4 and 5. FIG. 4 is a simplified diagram illustrating contrast AF in 2D mode. FIG. 5 is a simplified diagram illustrating contrast AF in 3D mode.

First, contrast AF in 2D mode will be described. The digital video camera 100 uses an image in a predetermined region (detection area) in the captured image to perform contrast AF. That is, the digital video camera 100 prospectively decides the range over which the detection area is set. In 2D mode, the digital video camera 100 sets the center portion of a captured image as the detection area. The digital video camera 100 calculates an AF evaluation value (contrast value) on the basis of the brightness value of the image within the detection area. The digital video camera 100 controls the focus lens 170 so that this AF evaluation value has its maximum. This is contrast AF in 2D mode.

Next, contrast AF in 3D will be described. As shown in FIG. 5, in 3D mode the digital video camera 100 sets the center portion of the left-eye image and the center portion of the right-eye image as the detection area. The digital video camera 100 calculates the AF evaluation value for the left-eye image (first AF evaluation value) and the AF evaluation value for the right-eye image (second AF evaluation value) on the basis of the brightness value of each detection area, and calculates the AF evaluation value for the 3D image (third AF evaluation value; 3D image-use AF evaluation value) on the basis of these other AF evaluation values (the first AF evaluation value and the second AF evaluation value). The digital video camera 100 performs contrast AF on the basis of the 3D image-use AF evaluation value. The method for calculating the 3D image-use AF evaluation value will be discussed below. The AF evaluation value for the left-eye image and the AF evaluation value for the right-eye image are calculated by the same method as that used to calculate an AF evaluation value in 2D mode.

1-4. Contrast AF Control in 3D Mode

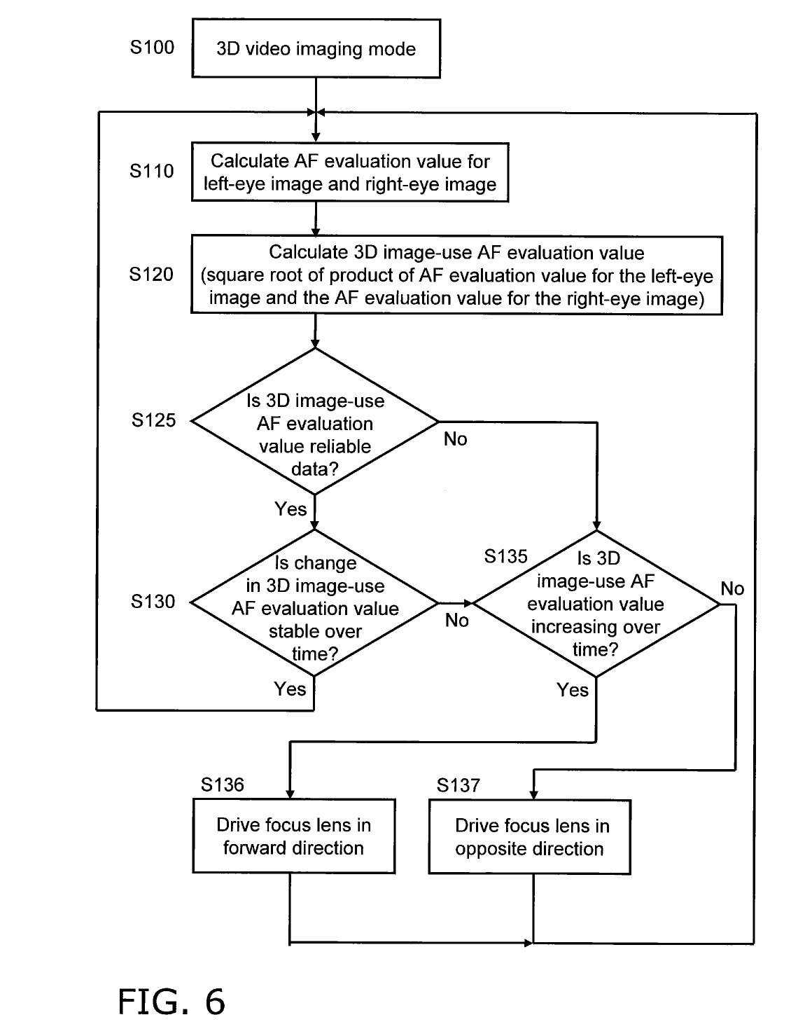

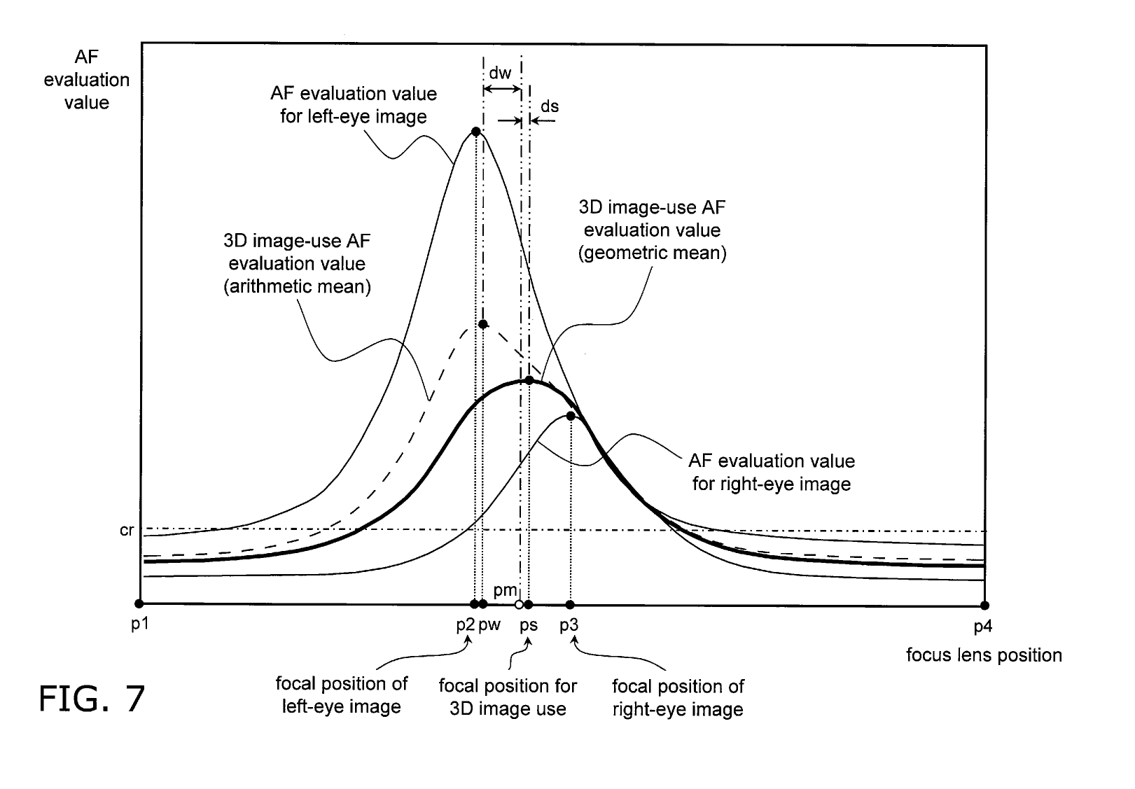

Contrast AF control in 3D mode will be described through reference to FIGS. 6 and 7. FIG. 6 is a flowchart illustrating contrast AF control in 3D mode. FIG. 7 is a simplified diagram illustrating AF evaluation values for a captured image.

The user manipulates the manipulation member 250 to set the digital video camera 100 to imaging mode (S100). When the digital video camera 100 is set to imaging mode, the controller 210 calculates the AF evaluation value for the left-eye image and the AF evaluation value for the right-eye image on the basis of the captured images (the left-eye image and the right-eye image) (S110).

Here, when the controller 210 calculates the AF evaluation value for the left-eye image and the AF evaluation value for the right-eye image, the controller 210 calculates the product of the AF evaluation value for the left-eye image and the AF evaluation value for the right-eye image (S120). When the controller 210 calculates the product of the AF evaluation value for the left-eye image and the AF evaluation value for the right-eye image, the controller 210 calculates the square root of the product (S120). The controller 210 then recognizes the square root of the product of the AF evaluation value for the left-eye image and the AF evaluation value for the right-eye image as the 3D image-use AF evaluation value. The 3D image-use AF evaluation value is calculated in this way with the digital video camera 100.

Then, when the controller 210 calculates the 3D image-use AF evaluation value, the controller 210 determines whether or not the 3D image-use AF evaluation value is reliable data (S125). Here, if there is a large amount of change in the 3D image-use AF evaluation value with respect to the change in the position of the focus lens 170, it is determined that the 3D image-use AF evaluation value is reliable data. On the other hand, if there is a small amount of change in the 3D image-use AF evaluation value with respect to the change in the position of the focus lens 170, it is determined that the 3D image-use AF evaluation value is not reliable data.

More specifically, in S125, the controller 210 determines whether or not the 3D image-use AF evaluation value is at or above a specific threshold (reference value cr). The reference value cr is an index for determining whether or not the 3D image-use AF evaluation value is reliable data. As shown in FIG. 7, in a range in which the 3D image-use AF evaluation value is at or above the reference value cr, the amount of change in the above-mentioned 3D image-use AF evaluation value is at or above a specific value. In this case, the controller 210 determines the 3D image-use AF evaluation value to be reliable data. On the other hand, in a range in which the 3D image-use AF evaluation value is less than the reference value cr, the amount of change in the above-mentioned 3D image-use AF evaluation value is less than a specific value. In this case, the controller 210 determines that the 3D image-use AF evaluation value is not reliable data.

If the 3D image-use AF evaluation value is reliable data, such as when the 3D image-use AF evaluation value is at or above the reference value cr (Yes in S125), the controller 210 determines whether or not the change in the 3D image-use AF evaluation value is stable over time (S130). More specifically, the controller 210 determines whether or not the 3D image-use AF evaluation value for the current field is less than a specific value with respect to the 3D image-use AF evaluation value of one field before.

Here, if the change in the 3D image-use AF evaluation value is stable over time, such as when the change over time in the 3D image-use AF evaluation value is less than a specific value (Yes in S130), the controller 210 executes the processing from S110 onward again. A case in which the change in the 3D image-use AF evaluation value here is stable over time corresponds to a case in which the 3D image-use AF evaluation value is near the peak value. Specifically, in this case, the focus lens 170 is located near the lens position for the peak 3D image-use AF evaluation value, that is, near the target lens position ps (discussed below).

The captured image changes over time, according to the change over time in the subject. Therefore, when the processing from S110 onward is executed after the processing of S130, the AF evaluation value for the left-eye image and the AF evaluation value for the right-eye image produced in S110 will vary according to the change over time in the captured image. Specifically, when the processing from S110 onward is repeatedly executed after the processing of S130, the 3D image-use AF evaluation values repeatedly produced in S120 also vary.

On the other hand, if the 3D image-use AF evaluation value is not reliable data (No in S125), or if the change in the 3D image-use AF evaluation value is not stable over time (No in S130), the controller 210 determines whether or not the 3D image-use AF evaluation value is increasing over time (S135). More specifically, the controller 210 determines whether or not the 3D image-use AF evaluation value of the current field is greater than the 3D image-use AF evaluation value of one field before.

Here, if the 3D image-use AF evaluation value is not reliable data (No in S125), the change in the 3D image-use AF evaluation value is small with respect to the change in the position of the focus lens 170. In this case, the controller 210 may not be able to decide on the drive direction of the focus lens 170. If this should happen, the controller 210 moves the focus lens 170 in the current forward direction until it can decide on the drive direction of the focus lens 170. Once the amount of change in the 3D image-use AF evaluation value with respect to the change in the position of the focus lens 170 has reached a level at which the drive direction of the focus lens 170 can be decided, the controller 210 halts the drive of the focus lens 170. The controller 210 then determines whether or not the 3D image-use AF evaluation value is increasing over time, as discussed above (S135).

If the controller 210 has determined that the 3D image-use AF evaluation value is increasing over time (Yes in S135), the controller 210 drives the focus lens 170 by a specific amount in the current forward direction (S136). On the other hand, if the controller 210 has determined that the 3D image-use AF evaluation value is not increasing over time (No in S135), the controller 210 drives the focus lens 170 by a specific amount in the direction opposite to the current forward direction (S137). Once the drive of the focus lens 170 is finished, the controller 210 again executes the processing from S110 onward.

This series of processing (the processing of S110 to S137) is repeatedly executed by the controller 210 until imaging is stopped.

Thus, the digital video camera 100 pertaining to Embodiment 1 calculates the 3D image-use AF evaluation value on the basis of the AF evaluation value for the left-eye image and the AF evaluation value for the right-eye image. The reason for this configuration will be described below.

If the left-eye lens 520 and the right-eye lens 510 of the 3D conversion lens 500 are attached without being inclined with respect to the imaging plane, the focus lens 170 is set at a certain position. This allows the left-eye image and right-eye image to be focused at the same time. More precisely, when the focus lens 170 is in a specific position, the AF evaluation value for the left-eye image coincides with the AF evaluation value for the right-eye image. That is, in this case the focal position of the left-eye image coincides with the focal position of the right-eye image. In actual practice, however, the left-eye lens 520 and the right-eye lens 510 of the 3D conversion lens 500 may each end up being inclined within a tiny range with respect to the imaging plane. Also the optical system within the digital video camera 100 may end up being inclined within a tiny range with respect to the imaging plane. If the left-eye lens 520 and the right-eye lens 510 of the 3D conversion lens 500, or the optical system within the digital video camera 100 thus ends up being inclined to the imaging plane, there is the risk that the AF evaluation value for the left-eye image and the AF evaluation value for the right-eye image may end up being different, as shown in FIG. 7. That is, there is the risk that the focal position of the left-eye image and the focal position of the right-eye image will end up being different.

Therefore, in this state, if contrast AF is executed on the basis of either the AF evaluation value for the left-eye image or the AF evaluation value for the right-eye image, there is the risk that there will be a larger amount of defocus with respect to the left-eye image and right-eye image. As a result, if a 3D image is displayed on the basis of the left-eye image and right-eye image, the user will have a hard time seeing the 3D image.

In view of this, with the digital video camera 100 pertaining to Embodiment 1, a 3D image-use AF evaluation value that allows a 3D image to be properly displayed is calculated on the basis of the AF evaluation value for the left-eye image and the AF evaluation value for the right-eye image. By using this 3D image-use AF evaluation value, there is less defocus with respect to the left-eye image and right-eye image, so when a 3D image is displayed on the basis of the left-eye image and right-eye image, it is easier for the user to see the 3D image.

The method for evaluating the 3D image-use AF evaluation value will be described in detail through reference to FIG. 7. The horizontal axis in FIG. 7 corresponds to the optical axis of the optical system over which the focus lens 170 moves. In FIG. 7, the initial position of the focus lens 170 is labeled p1, and the position where the focus lens 170 is farthest away from the initial position p1 (maximum separation position) is labeled p4. The position of the focus lens 170 with respect to the peak of the AF evaluation value for the left-eye image is called the first lens position p2, while the position of the focus lens 170 with respect to the peak of the AF evaluation value for the right-eye image is called the second lens position p3. The midpoint between the first lens position p2 and the second lens position p3 is the lens position at which there is the least defocus with respect to the left-eye image and right-eye image, and this lens position is called the optimal lens position pm.

As discussed above, if the left-eye lens 520 and the right-eye lens 510 are inclined to the imaging plane, the first lens position p2 with respect to the peak of the first AF evaluation value for the left-eye image does not coincide with the second lens position p3 with respect to the AF evaluation value for the right-eye image. If the AF evaluation value for the left-eye image and the AF evaluation value for the right-eye image are calculated in this state, as shown in FIG. 7, the absolute value of the difference between the peak of the AF evaluation value for the left-eye image and the peak of the AF evaluation value for the right-eye image often becomes great.

In this case, if the 3D image-use AF evaluation value is evaluated from ½ the sum of the AF evaluation value for the left-eye image and the AF evaluation value for the right-eye image, then this 3D image-use AF evaluation value (hereinafter referred to as the 3D image-use AF evaluation value (arithmetic mean)) will be strongly affected by the higher AF evaluation value (the AF evaluation value for the left-eye image or the AF evaluation value for the right-eye image), such as by the AF evaluation value for the left-eye image in FIG. 7. Consequently, as shown in FIG. 7, the lens position pw with respect to the peak of the 3D image-use AF evaluation value (arithmetic mean) ends up approaching the first lens position p2. Specifically, the lens position pw of the focus lens 170 ends up moving away from the optimal lens position pm. Therefore, when the focus lens 170 is moved toward the lens position pw on the basis of the 3D image-use AF evaluation value (arithmetic mean), there is the risk that the defocus with respect to the left-eye image and right-eye image ends up being great. In FIG. 7, the distance between the lens position pw and the optimal lens position pm of the focus lens 170 is labeled dw.

In contrast, when the 3D image-use AF evaluation value is evaluated from the square root of the product of the AF evaluation value for the left-eye image and the AF evaluation value for the right-eye image, even if the difference between the of the AF evaluation value for the left-eye image and the peak of the AF evaluation value for the right-eye image has a high absolute value, this 3D image-use AF evaluation value (hereinafter referred to as the 3D image-use AF evaluation value (geometric mean)) does not be strongly affected by the higher AF evaluation value (the AF evaluation value for the left-eye image or the AF evaluation value for the right-eye image), such as by the AF evaluation value for the left-eye image in FIG. 7.

Therefore, when the 3D image-use AF evaluation value (geometric mean) is used, the lens position ps with respect to the peak of the 3D image-use AF evaluation value (geometric mean) (hereinafter referred to as the target lens position) is closer to the optimal lens position pm than when the 3D image-use AF evaluation value (arithmetic mean) is used. More specifically, as shown in FIG. 7, the distance ds between the target lens position ps and the optimal lens position pm is shorter than the distance dw between the lens position pw and the optimal lens position pm. Therefore, when the position of focus lens 170 is moved toward the target lens position ps on the basis of the 3D image-use AF evaluation value (geometric mean), defocus with respect to the left-eye image and right-eye image is reduced. For this reason, in Embodiment 1 the position of the focus lens 170 is set on the basis of the 3D image-use AF evaluation value (geometric mean).

Finally, control during production of a 3D moving picture and control during production of a 3D still picture will be described. Embodiment 1 above can be applied to both control during production of a 3D moving picture and control during production of a 3D still picture. However, the drive of the focus lens 170 can be controlled more effectively when Embodiment 1 is applied to a 3D moving picture than when it is applied to a 3D still picture. The control of the focus lens 170 will now be described with this in mind, through reference to FIG. 7.

As discussed above, if the left-eye lens 520 and the right-eye lens 510 are inclined to the imaging plane, the first lens position p2 may not coincide with the second lens position p3. Here, if the focus lens 170 is set to either the first lens position p2 or the second lens position p3, there ends up being a large amount of defocus between the right-eye image and left-eye image. Specifically, this will result in video that is extremely difficult to see as a 3D image. To solve this problem, it is important to keep the defocus in the left-eye image and right-eye image to a minimum.

For instance, in the case of a 3D still picture, the image used for the 3D still picture is not recorded until the imaging button is pressed. Therefore, the controller 210 can move the focus lens 170 anywhere along the optical axis of the optical system, and the distribution of the AF evaluation value for the right-eye image and the distribution of the AF evaluation value for the left-eye image can be found up until the imaging button is pressed. For instance, if FIG. 7 is interpreted as a diagram of the AF evaluation value for a 3D still picture, the controller 210 moves the focus lens 170 over the entire range of the horizontal axis in FIG. 7 to produce the distribution of the AF evaluation value for the right-eye image and the distribution of the AF evaluation value for the left-eye image.

As a result, the controller 210 detects the first lens position p2 and the second lens position p3 on the basis of the distribution of the AF evaluation value for the right-eye image and the distribution of the AF evaluation value for the left-eye image. The controller 210 then sets the focus lens 170 to the position of the midpoint between the first lens position p2 and the second lens position p3, that is, to the optimal lens position pm. Thus, with a 3D still picture, the extent of defocus in the right-eye image and left-eye image can be reduced.

On the other hand, with a 3D moving picture, the image used for the 3D moving picture is recorded in real time as time series data. Therefore, with a 3D moving picture, the focus lens 170 cannot moved anywhere along the optical axis of the optical system to find the distribution of the AF evaluation value for the right-eye image and the distribution of the AF evaluation value for the left-eye image, as is possible with a 3D still picture. The reason for this is that if the focus lens 170 is moved over the entire range of the optical axis of the optical system (the entire range of the horizontal axis in FIG. 7) in order to produce the distribution of the AF evaluation value for the right-eye image and the distribution of the AF evaluation value for the left-eye image, for example, an image will end up being recorded as time series data while the focus lens 170 is moving, and an unnatural 3D moving picture will be produced.

Because of this, in the case of a 3D moving picture, the first lens position p2 and the second lens position p3 are not detected, nor is the focus lens 170 set to the optimal lens position pm, on the basis of the distribution of the AF evaluation value for the left-eye image and the AF evaluation value for the right-eye image. Specifically, in the case of a 3D moving picture, drive of the focus lens 170 cannot be controlled in the same mode as with a 3D still picture.

In view of this, let us here consider controlling the drive of the focus lens 170 for a 3D moving picture by the method used in the past for moving pictures. For example, in FIG. 7, when the focus lens 170 moves from the left to the right over the horizontal axis in a state in which it is located between the initial position p1 and the first lens position p2, the AF evaluation value for the left-eye image and the AF evaluation value for the right-eye image both increase. In this case, the controller 210 determines that the focus lens 170 is moving toward the peak of the two AF evaluation values, and moves the focus lens 170 in the current forward direction (to the right in FIG. 7). When the focus lens 170 moves from the right to the left over the horizontal axis in this state, the AF evaluation value for the left-eye image and the AF evaluation value for the right-eye image both decrease. In this case, the controller 210 determines that the focus lens 170 is moving away from the peak of the two AF evaluation values, and moves the focus lens 170 in the opposite direction (to the right in FIG. 7) from the current forward direction.

When the focus lens 170 moves from the left to the right over the horizontal axis in a state of being located between the second lens position p3 and the maximum separation position p4, the AF evaluation value for the left-eye image and the AF evaluation value for the right-eye image both decrease. In this case, the controller 210 determines that the focus lens 170 is moving away from the peak of the two AF evaluation values, and moves the focus lens 170 in the opposite direction (to the left in FIG. 7) from the current forward direction. When the focus lens 170 moves from the right to the left over the horizontal axis in this state, the AF evaluation value for the left-eye image and the AF evaluation value for the right-eye image both increase. In this case, the controller 210 determines that the focus lens 170 is moving toward the peak of the two AF evaluation values, and moves the focus lens 170 in the current forward direction (to the left in FIG. 7).

On the other hand, in FIG. 7, when the focus lens 170 is located between the first lens position p2 and the second lens position p3, the AF evaluation value for the left-eye image decreases from the first lens position p2 toward the second lens position p3, and the AF evaluation value for the right-eye image increases. In this case, the controller 210 cannot determine whether the focus lens 170 should be moved in the current forward direction or in the opposite direction from the current forward direction. Specifically, in this case the controller 210 ends up being unable to decide on the position of the focus lens 170. Therefore, drive of the focus lens 170 with a 3D moving picture cannot be controlled by the methods used in the past for moving pictures.

In view of this, in Embodiment 1, the focus lens 170 is controlled by the controller 210 so that this problem can be solved. For example, a new evaluation value, namely, the 3D image-use AF evaluation value, is produced on the basis of the AF evaluation value for the left-eye image and the AF evaluation value for the right-eye image. More specifically, as discussed above, the 3D image-use AF evaluation value (geometric mean) is produced by calculating the square root of the product of the AF evaluation value for the left-eye image and the AF evaluation value for the right-eye image.

Next, the controller 210 controls the drive of the focus lens 170 on the basis of the 3D image-use AF evaluation value. In this case, there is only one 3D image-use AF evaluation value for a single lens position on the horizontal axis in FIG. 7, so the controller 210 can move the focus lens 170 and decide on the position of the focus lens 170 on the basis of the increase or decrease in the 3D image-use AF evaluation value.

For example, the 3D image-use AF evaluation value increases when the focus lens 170 moves from the left to the right over the horizontal axis in a state of being located between the initial position p1 and the target lens position ps. In this case the controller 210 determines that the focus lens 170 is moving toward the peak of the 3D image-use AF evaluation value, and moves the focus lens 170 in the current forward direction (to the right in FIG. 7). Also, the 3D image-use AF evaluation value decreases when the focus lens 170 moves from the right to the left over the horizontal axis in this state. In this case the controller 210 determines that the focus lens 170 is moving away from the peak of the 3D image-use AF evaluation value, and moves the focus lens 170 in the opposite direction (to the right in FIG. 7) from the current forward direction.

Also, since the 3D image-use AF evaluation value decreases when the focus lens 170 moves from the left to the right in a state of being located between the target lens position ps and the maximum separation position p4, the controller 210 determines that the focus lens 170 is moving away from the peak of the 3D image-use AF evaluation value, and moves the focus lens 170 in the opposite direction (to the left in FIG. 7) from the current forward direction. Since the 3D image-use AF evaluation value increases when the focus lens 170 moves from the right to the left in this state, the controller 210 determines that the focus lens 170 is moving toward the peak of the 3D image-use AF evaluation value, and moves the focus lens 170 in the current forward direction (to the left in FIG. 7).

Thus, in Embodiment 1, the position of the focus lens 170 can be reliably set over the entire range along the optical axis of the optical system (the entire range from the initial position p1 to the maximum separation position p4 in FIG. 7) by using a new evaluation value, namely, the 3D image-use AF evaluation value. Also, since the controller 210 can always move the focus lens 170 toward the target lens position ps, the amount of defocus in the left-eye image and right-eye image can be reduced.

### Other Embodiments

### 2. Other Embodiments

Embodiment 1 was described above as an embodiment of the present technology, but the present technology is not limited to or by this. Other embodiments of the present technology will be described below.

The optical system and drive system of the digital video camera 100 pertaining to this embodiment are not limited to what is shown in FIG. 3. For instance, the optical system components 110, 140, and 170 are shown as examples of a three-group configuration in FIG. 3, but the lens configuration may have some other group makeup. Also, the lenses 110, 140, and 170 of the optical system may be configured as a lens group made up of a plurality of lenses, rather than just one lens.

Also, in Embodiment 1, an example was given in which a 3D moving picture was captured in a state in which the 3D conversion lens 500 was attached to the digital video camera 100, but the present technology is not limited to this. For example, the right-eye lens 510 and the left-eye lens 520 may be built into the digital video camera 100. In this case, the imaging system 300 shown in FIG. 3 is provided to each of the lenses 510 and 520 in the digital video camera 100. Specifically, the digital video camera 100 is equipped with a two-part imaging system 300. In this case, two images, namely, the left-eye image and the right-eye image, are produced by the imaging systems 300. The left-eye image and the right-eye image are each subjected to the processing from S110 to S140. Thus, even when the right-eye lens 510 and the left-eye lens 520 are built into the digital video camera 100, the present technology can be worked just as in Embodiment 1.

Also, in Embodiment 1 the CCD image sensor 180 was given as an example of an imaging mode, but the present technology is not limited to this. For example, a CMOS image sensor may be used, or an NMOS image sensor may be used.

Also, in Embodiment 1, in contrast AF in 3D mode, the product of the AF evaluation value for the left-eye image and the AF evaluation value for the right-eye image was calculated, and the square root was used as the 3D image-use AF evaluation value. However, this configuration does not necessarily have to be employed. For example, the configuration may be such that if the difference between the peak of the AF evaluation value for the left-eye image and the peak of the AF evaluation value for the right-eye image has a small absolute value, then the average of the AF evaluation value for the left-eye image and the AF evaluation value for the right-eye image is calculated and used as the 3D image-use AF evaluation value. In other words, the 3D image-use AF evaluation value may be calculated on the basis of the AF evaluation value for the left-eye image and the AF evaluation value for the right-eye image.

Also, in Embodiment, as shown in FIG. 5, an example was given in which the detection area was set to the center portion of the left-eye image and the center portion of the right-eye image, but the present technology is not limited to this. In other words, the present technology can be applied no matter the range over which the detection area is set in the left-eye image and right-eye image.

### INDUSTRIAL APPLICABILITY

The present technology can be applied to a digital video camera, a digital still camera, or another such imaging device.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the imaging device. Accordingly, these terms, as utilized to describe the technology disclosed herein should be interpreted relative to the imaging device.

The term “configured” as used herein to describe a component, section, or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicants, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An imaging device, comprising:
an optical system configured to include a focus lens;
an imaging unit configured to capture a left-eye subject and a right-eye subject via the optical system, a image captured by the imaging unit including a left-eye image for the left-eye subject and a right-eye image for the right-eye subject; and
a control unit configured to generate a first AF evaluation for the left-eye image and a second AF evaluation for the right-eye image, generate a third AF evaluation value on the basis of the first AF evaluation value and the second AF evaluation value, and control the drive of the focus lens on the basis of the third AF evaluation value.

2. The imaging device according to claim 1, wherein:
the control unit controls the drive of the focus lens on the basis of the third AF evaluation value generated on the basis of the product of the first AF evaluation value and the second AF evaluation value.

3. The imaging device according to claim 2, wherein:
the control unit controls the drive of the focus lens on the basis of the third AF evaluation value corresponding to the square root of the product.

4. The imaging device according to claim 3, wherein:
the control unit drives the focus lens in the direction in which the third AF evaluation value increases.

5. The imaging device according to claim 1, further comprising:
a recorder configured to record the image captured by the imaging unit, wherein
the control unit sets the position of the focus lens at the next clock time on the basis of the third AF evaluation value at a clock time, and
the recorder records the image captured in a state in which the focus lens has been set to the position.

6. The imaging device according to claim 1, further comprising:
image output unit configured to output light corresponding to the left-eye subject and light corresponding to the right-eye subject; and
an imaging device main body, wherein
the imaging device main body includes the optical system, the imaging unit, and the control unit,
the light corresponding to the left-eye subject and the light corresponding to the right-eye subject are inputted to the optical system.

7. The imaging device according to claim 1, further comprising:
an image output unit configured to output the light corresponding to the left-eye subject and the light corresponding to the right-eye subject, wherein
the light corresponding to the left-eye subject and the light corresponding to the right-eye subject are inputted to the optical system, and
the imaging unit captures the left-eye subject and the right-eye subject via the optical system.
